(19) United States
(12) Patent Application Publication
(10) Pub. No.: US 2026/0048919 A1
(43) Pub. Date: Feb. 19, 2026

(54) Water Filter Priming Bag Apparatus, Systems and Methods

(71) Applicant: Clearly Filtered, Inc., Rancho Santa Margarita, CA (US)

(72) Inventors: Asaiah Passwater, Ladera Ranch, CA (US); Frank M. Tyneski, Weaverville, NC (US); Johnny Lampley, Laguna Niguel, CA (US)

(73) Assignee: Clearly Filtered, Inc., Rancho Santa Margarita, CA (US)

(21) Appl. No.: 18/809,285

(22) Filed: Aug. 19, 2024

(51) Int. Cl. B65D 75/58; B01D 24/20; C02F 1/00

(52) U.S. Cl. CPC B65D 75/5883; B01D 24/205; C02F 1/003; C02F 2307/04

(57) ABSTRACT

A hand-held water filter priming bags for priming a high performance gravity fed water filters has a flexible water container portion permanently sealed to a threaded filter connector component. A handle extends longitudinally along at least substantially the entire diameter of a base section of the filter connector component. The handle comprises a continuous flange spanning substantially the diameter of the base section and surrounding an outlet extending through the base section. Flexible water container portion is sealed to the continuous flange. An interior of the water container portion is in fluid communication with an exterior of the bag via the outlet. The bag outlet is configured for highly targeted pressurization of high-performance filters. A priming bag system includes the hand-held water filter priming bag. Methods of priming allow for efficient fully priming of high performance filters.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS REFERENCE TO RELATED APPLICATIONS

N/A

### STATEMENT REGARDING FEDERAL RIGHTS

N/A

### TECHNICAL FIELD

Aspects of the present technology are directed to water filter priming bags and, in particular but not exclusively, to hand held water filter priming bags for manually priming pitcher gravity fed water filters at the point of use by the end user. Some embodiments are directed to hand held water filter priming bags for manually priming high performance pitcher gravity fed water filters. Some aspects of the present technology are directed to water filter priming systems which combine the water filter priming bags in combination with high performance pitcher water pitcher gravity fed filters and/or other types of gravity fed filters. Some aspects of the present technology are directed to methods for priming gravity fed water filters and, in particular but not exclusively, to methods of manually priming high performance pitcher gravity fed water filters.

### BACKGROUND

Gravity fed water filters are used in water pitchers and other portable water filters. The rate of water flow through the filter is typically directly proportional to the number of contaminants removed. Gravity fed water filters with inferior performance standards are easier to prime and flow more freely. For example, a loosely packed filter, though not ideal at removing containments, allows water to flow quickly through the filter and supports simple methods for filter priming, such as passive soaking before use.

“Soak before use” methods for priming gravity fed water filters are laborious and time consuming as they require soaking the filters in water for several hours or overnight to ensure adequate priming of the filters.

Furthermore, passive soaking methods for priming do not lend themselves well to priming of high performance gravity fed water filters. These types of filters have filter media densely packed into the filter housing and use high density filter elements. High performance gravity fed water filters contain more types of contaminant filtering media than other loosely packed low performance gravity-fed filtering systems. High performance gravity fed water filters expose untreated water to significantly more surface area during the purification process, which namely involves pushing water, by way of gravity, through a variety of media substrates that are compressed into a solid element that is porous.

There is a need to provide improved priming apparatus, methods and/or systems for priming pitcher gravity-fed water filters and/or other types of portable gravity fed-water filters.

### SUMMARY

According to some aspects there is provided a hand-held water filter priming bag for priming a high performance gravity fed water filter. The filter may comprise a water container portion made from flexible material; and a a filter connector component made from a rigid material; the water container portion being permanently sealed to the filter connector component; wherein the water container portion has a closed upper end and a bottom end; wherein the filter connector component comprises a base section; a handle integrated with an upper side of the base section; and an outlet; wherein the handle extends longitudinally along at least substantially the entire diameter the base section; wherein the handle comprises a continuous flange spanning substantially the diameter of the base section and surrounding the outlet, wherein at least a portion of the bottom end of the water container portion is permanently sealed to a sealing surface of the continuous flange surrounding the outlet; and wherein an interior of the water container portion is in fluid communication with an exterior of the water filter priming bag via the outlet.

In some embodiments, filter connector component is a molded single piece body.

In some embodiments, the filter connector component is a threaded filter connector component for threading to a pitcher gravity fed water filter.

In some embodiments, the outlet, continuous flange and threads of the threaded filter connector component are concentric with one another.

In some embodiments, opposite ends of the handle extend longitudinally beyond the perimeter of the upper side of the base section.

In some embodiments, the continuous flange comprises a sidewall standing upright from the upper side of the base section.

In some embodiments, the sealing surface comprises an upright surface on the exterior side of the flange sidewall.

In some embodiments, the continuous flange is a rhombus flange.

In some embodiments, the outlet has a cross-sectional area that corresponds to a substantial surface area of a filter inlet of a high performance pitcher gravity fed water filter.

In some embodiments, the upper end of the water container portion incorporates an upper gusset, the upper gusset having a surface area covering the continuous flange.

In some embodiments, the outlet comprises a tubular section extending perpendicularly between the upper side and a bottom of the base section.

In some embodiments, a pair of venting through holes are disposed in the upper side of the base section, wherein the through holes are surrounded by the continuous flange and spaced either side of the outlet, the interior of the water container portion being in fluid communication with the underside of the base section via the respective through holes.

Any technical features of the aforementioned embodiments may be combined with each other, where appropriate.

According to some other aspects of the present technology, a water filter priming system is provided. The Water filter priming system may comprise a gravity fed water filter housing; and a hand-held priming bag of any of one of the aforementioned embodiments attachable to the gravity fed filter device; wherein the gravity fed water filter housing has a filter inlet comprising at least one inlet aperture; and wherein, when the hand held water filter priming bag is attached to the gravity fed water filter housing, the filter connector component of the hand held water filter priming bag is substantially sealed to the filter housing, the outlet of the hand held priming bag is disposed adjacent and substantially concentric with the filter inlet, and an aperture of the outlet has an aperture area that covers a substantial amount of the total inlet aperture area(s) of the pitcher gravity fed water filter.

In some embodiments, the filter inlet comprises a plurality of inlet apertures distributed spaced apart over a surface area of the filter housing.

In some embodiments, when the hand-held water filter priming bag is attached to the gravity fed water filter housing, the outlet aperture area covers a surface region of the filter housing that comprises at least 50% of the total inlet aperture area(s) of the pitcher gravity fed water filter.

In some embodiments, when the hand-held water filter priming bag is attached to the gravity fed water filter housing, the outlet aperture area covers a surface region of the filter housing that comprises at least 67% of the total inlet aperture area(s) of the pitcher gravity fed water filter.

In some embodiments, the filter further comprises a filter media enclosed in the filter housing.

In some embodiments, the gravity fed water filter is a high performance pitcher gravity fed water filter.

In some embodiments, the high performance gravity filter is configured to have at least a contaminant reduction rate of up to 95% of ammonia, calcium hypochlorite, chloramine, chlorine, nitrate, sulfate, lead, and nickel.

Any technical features of the aforementioned embodiments may be combined with each other, where appropriate.

According to some other aspects of the present technology, methods for priming a gravity fed water filter are provided. The methods may comprise providing a water filter priming bag according to any one of the aforementioned embodiments; filling the water filter priming bag with water; while holding the water filter priming bag filled with water, attaching a high-performance pitcher gravity fed water filter to the water filter priming bag so that outlet aperture covers a surface area of the filter housing that comprises at least 50% of the total inlet aperture area(s) of the pitcher gravity fed water filter; fully priming the gravity water fed filter with one use of the water filter priming bag by squeezing the filled water container portion to force the water in the water container portion through the outlet and through the filter inlet; and detaching the filter priming bag from the high performance pitcher gravity fed water filter.

According to some other aspects of the present technology, a hand-held water filter priming bag is provided. The hand-held water filter priming bag may comprise a water container portion made from flexible material and a filter connector component made from a rigid single piece body of material; the water container portion being permanently sealed to the filter connector component; wherein the water container portion has a closed upper end and a bottom end; wherein the filter connector has a continuous flange integrated with an upper side of the filter connector; and an outlet; wherein at least a portion the bottom end of the water container portion is permanently sealed to a sealing surface of the continuous flange surrounding the outlet; and wherein an interior of the water container portion is in fluid communication with an exterior of the water filter priming bag via the outlet.

In some embodiments, the continuous flange extends longitudinally along at least substantially the length of the diameter the filter connector component.

In some embodiments, the continuous flange spans substantially the diameter of the filter connector component.

Any technical features of the aforementioned embodiments may be combined with each other or each of the other aspects, where appropriate.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 depicts a top front perspective view of an embodiment of a hand-held water pitcher filter priming bag according one aspect of the present technology;

FIG. 2 depicts an exploded view of the of priming bag of FIG. 1;

FIG. 3 depicts a bottom perspective view of the priming bag of FIG. 1;

FIG. 4 depicts a plan a view of a bottom end of the priming bag of FIG. 1;

FIG. 5 depicts a cross-sectional view taken as indicated by line 3-3 in FIG. 1;

FIG. 6 depicts an exploded cross-sectional view taken as indicated by line 4-4 of in FIG. 2;

FIG. 7 depicts enlarged partial view of FIG. 5;

FIG. 8 depicts a perspective view of an embodiment of a high performance water filter priming system in an assembled configuration according to another aspect of the present technology;

FIG. 9 depicts a perspective view of the system of FIG. 8 in a disassembled configuration in which the outlet of the hand-held water filter priming bag is aligned with and spaced apart from the inlet of the high performance gravity fed water filter;

FIG. 10 depicts a cross-sectional view taken as indicated by the line 8-8 of the system of FIG. 8.

FIG. 11 depicts a cross-sectional view taken as indicated by the line 9-9 of the system of FIG. 9;

FIG. 12 depicts an enlarged partial view of FIG. 10;

FIG. 13 depicts a top plan view of the pitcher gravity fed water filter shown in FIG. 9 indicating the amount of the surface area of the filter inlet that will be covered by the outlet of the priming bag when the priming bag is attached to the filter;

FIG. 14 depicts a hand-held water filter priming bag of FIG. 1 flipped upside down and being filled with water via the outlet aperture of the bag;

FIG. 15 depicts the water filter priming bag from FIG. 14 filled with water and being screwed to a high performance pitcher gravity fed water filter water filter; and

FIG. 16 depicts the priming bag and filter assembly from FIG. 15 flipped over and the priming bag being used to manually fully prime the high performance pitcher gravity fed water filter;

FIG. 17 depicts the priming bag from FIG. 16, now empty after priming the gravity fed filter, being unscrewed from the water filter priming bag.

### LIST OF REFERENCE NUMERALS

10—one hand held water filter priming bag
11—water container portion first and second sidewall sealed edges
12—water container portion upper end
13—water container portion upper gusset
14—water container portion bottom end
15—water container upper end
16—water container portion interior
17—hand held water filter priming bag
18—twist handle
19—water container portion base section
20—outlet aperture
22—single body threaded filter connector component
24—continuous flange sealing surface
23—water container portion base section upper side
25—threaded outer rim
26—upper side planar surface
27—continuous flange
28, 29—twist handle opposite ends
30—first sidewall bottom edge
31—second sidewall bottom edge
32—outlet
33—outlet bottom end
34, 35—filter component connector venting through holes
36—upper tubular section
37—lower tubular section
38—water container portion base section rim
40—water container portion
50—pitcher water gravity fed water filter
51—water container portion outer rim inner edge
52—gravity fed water filter cup section
53—gravity fed water filter base
55—filter large inlet aperture
56—filter small inlet aperture
57—filter ring
58—filter mesh
59,60—filter high density filter materials
61—imaginary circle representing outlet aperture coverage
100—pitcher gravity fed water filter priming system

### DETAILED DESCRIPTION OF PREFERRED EMBODIMENTS

In the following description, for purposes of explanation and not limitation, specific details are set forth, such as particular embodiments, procedures, techniques, etc. in order to provide a thorough understanding of the present technology. However, it will be apparent to one skilled in the art that the present technology may be practiced in other embodiments that depart from these specific details.

The terms “seal” “sealed” or “sealable” are used herein to mean a seal that is sufficient to provide a water tight seal for normal operation of the priming bag and/or water filter, as appropriate.

Technical features described in this application can be used to construct various aspects and embodiments of improved gravity fed water filter priming bags, systems and/or methods.

In some approaches, technical features described in this application can be used to construct various aspects and embodiments of water filter priming bags for priming pitcher gravity fed water filters.

In some other approaches, technical features described in this application can be used to construct various aspects and embodiments of water filter priming systems in which water filter priming bags are used in combination with pitcher gravity fed water filters and/or other types of water filters.

In some other approaches, technical features described in this application can be used to construct various aspects and embodiments of methods for priming gravity fed water filters or other types of water filters using the water filter priming bags of embodiments described herein.

It has been identified that known pitcher water filter priming bags require assembly of multiple parts at the point of end use, are cumbersome to handle, and inefficient for priming gravity fed water filters, especially high performance pitcher gravity fed filters.

By way of example, in order to more adequately explain the present technology, reference will be made in more detail hereinafter to approaches of the present technology in which water filter priming bag apparatus, systems and/or methods are configured for priming high performance pitcher gravity fed water filters. However, it will be understood that in some other approaches, the water filter priming bag may be used to prime lower performance pitcher gravity fed water filters or even other types of water filters.

As will be made apparent below, the water filter priming bag, systems and methods of the present technology, mitigate or overcome one or more of the aforementioned technical problems associated with known water filter priming bags. In comparison to known priming bags, the water filter priming bag design of the present technology allows easier and more efficient priming of pitcher gravity fed water filters at the point of use by an end user. The water filter priming bag of at least some embodiments of the present technology enables a high performance pitcher water gravity fed filter to be adequately primed with a single squeeze of the bag or at least without having to refill the priming bag and perform further priming of the filter.

Reference will now be made to the drawings in which the various elements of embodiments will be given numerical designations and in which embodiments will be discussed so as to enable one skilled in the art to make and use the invention.

Specific reference to components, process steps, and other elements are not intended to be limiting. Further, it is understood that like parts bear the same reference numerals, when referring to alternate Figures. It will be further noted that the Figures are schematic and provided for guidance to the skilled reader and are not necessarily drawn to scale. Rather, the various drawing scales, aspect ratios, and numbers of components shown in the Figures may be purposely distorted to make certain features or relationships easier to understand.

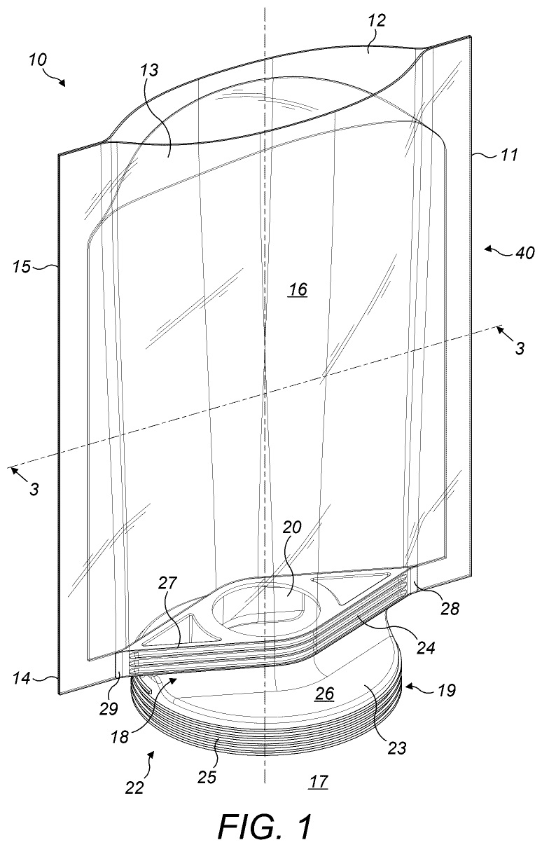

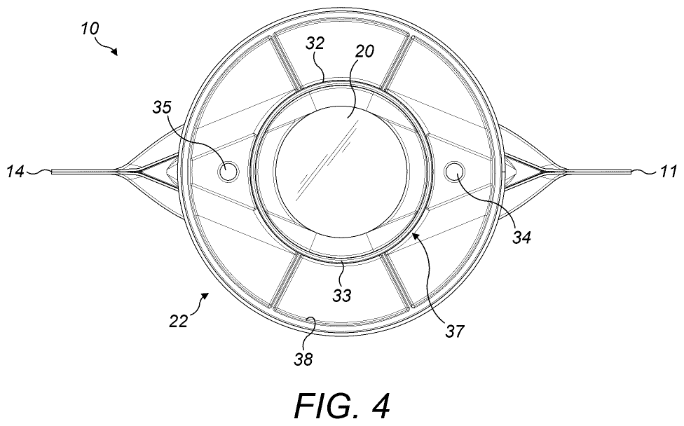

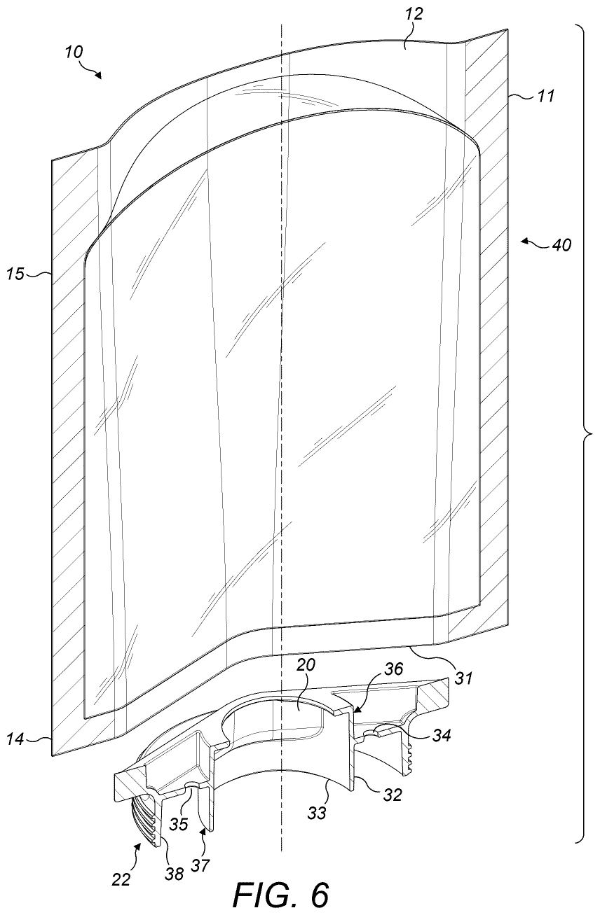

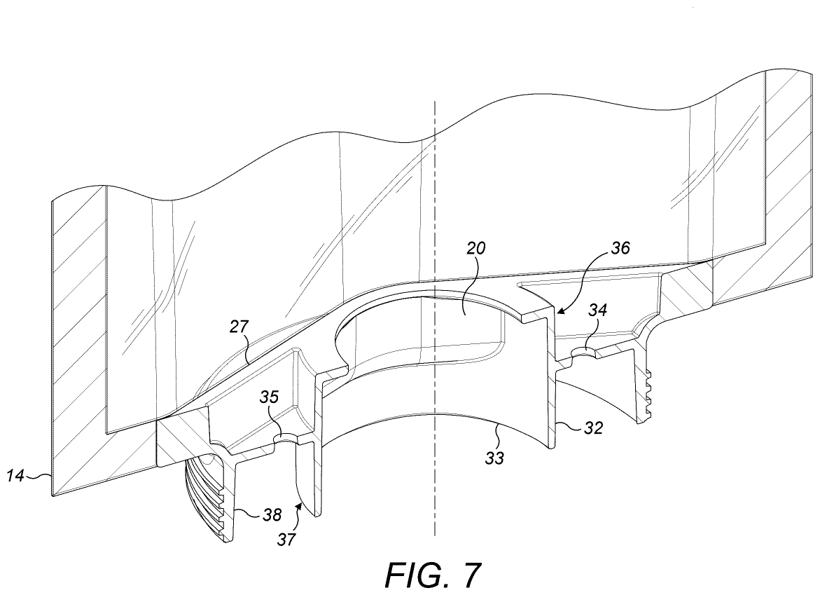

Referring now to the FIGS. 1-7 of the accompanying drawings, a one-piece hand held priming bag for priming high performance pitcher gravity fed water filters is shown and described according to an aspect of the present technology.

Broadly, hand-held water filter priming bag 10 has a water container portion 40 made from flexible material and a threaded filter connector component 22 made from a rigid material. Water container portion 40 is permanently sealed to a threaded filter connector component 22. Threaded filter connector component 22 is configured to thread into a counterpart threaded based of a high-performance gravity fed water filter. Water container portion 40 has a closed upper end 15 and a bottom end 14. Filter connector component 22 includes a base section 19, a twist handle 18 integrated with an upper side 23 of the base section 19, and an outlet 32 in fluid communication with an interior 16 of water container portion 40. Handle 18 extends longitudinally along the entire diameter of filter connector component 22. Handle 18 is in the form of a continuous flange 27 spanning the diameter of the base section 19 and surrounding outlet 32. At least a portion of bottom end 14 is permanently sealed to a sealing surface 24 of continuous flange 27. Outlet 32, continuous flange 27 and the filter component connector threads are disposed concentric with one another.

Filter connector component 22 is a single piece body (unitary construction) made from a rigid material. The single piece body may be a molded single piece body of stiff plastic. In some other embodiments, single piece body is a 3D printed material. In some other embodiments, the single piece body is made from material permanently joined together by fusing, welding, or bonding to form filter connector component 22. The filter connector component material is sufficiently rigid or stiff to provide structural stability for supporting water container portion 40 filled with water and for connection to a filter housing.

Filter connector component 22 is a male threaded filter connector component for screwing into a corresponding a female threaded housing of a pitcher gravity fed water filter. It will be appreciated that in some other embodiments filter connector component 22 is a female threaded filter component for screwing into a corresponding male threaded housing of a pitcher gravity fed water filter. Furthermore, in some other embodiments, filter connector component 22 includes another type of fastener instead of the threads of component 22 for cooperating with a corresponding fastener of the filter housing. Base section 19 is circular in longitudinal cross section.

Base section 19 has a threaded outer rim 25 for threading to a counterpart threaded rim of a base of a gravity fed filter with which the filter priming bag is intended to be used. In some other embodiments, base section 19 of filter connector component 22 is threaded on the inside edge of outer rim 25.

Handle 18 extends along and beyond the entire diameter of base section 19. Twist handle 18 has a hybrid design that not only facilitates manual manipulation of bag 10 during use but also serves as the sealing surface 24 for permanently sealing water container portion 40 to filter connector component 22. Twist handle 18 can also facilitate manual threading of bag 10 into and/or out of corresponding threads of a filter to be primed.

Handle 18 has opposite ends 28,29 that extend beyond opposite sides of the perimeter of the threads of base section 19. In other embodiments, twist handle 18 may not extend beyond the diameter of the base section 19. In yet some other embodiments, handle 18 may extend substantially along the entire diameter to facilitate manipulation of priming bag 10 during use.

Handle 18 comprises a continuous flange 27 surrounding outlet 32. Continuous flange 27 is disposed on a planar surface of upper side 23 of base section 19. Continuous flange 27 spans the diameter of upper side 23 of base section 19. Bottom end 14 of water container portion 40 is permanently sealed to sealing surface 24 of flange 27 surrounding a circular aperture 20 of outlet 32.

The ratio of the diameter of the outlet aperture 20 to the diameter of the filter connector component threads is about 3.68 to 11.2. For example, the diameter of the outlet aperture 20 is about 3.68 cm and the diameter of the filter component threads is 11.2 cm. The diameter of the outlet bottom end 33 is 4.8 cm. In some other embodiments, the ratio may be different to achieve the required water pressurization (see below explanation of the system 100). In some embodiments, outlet aperture 20 and/or outlet bottom end 33 may be between 3.5 cm and 6.5 cm wide.

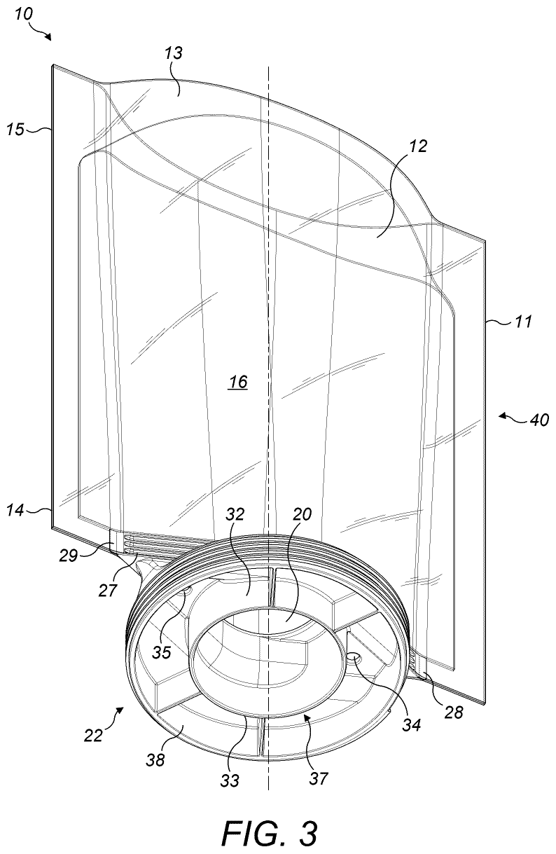

As best shown in FIGS. 3 & 4, interior 16 of water container portion 40 is in fluid communication with exterior 17 of water filter priming bag 10 via outlet 32 and water venting through holes 34,35. As best shown in FIGS. 3 & 5, outlet 32 comprises a tubular outlet section extending perpendicularly between the upper side and bottom side of filter connector 22. Tubular section 36,37 has an upper tubular section 36 and a lower tubular section 37. Upper tubular section 36 extends upwardly from upper side 26 of base section 19. Lower tubular section 37 extends downwardly through base section 19 and terminates at the bottom of base section 19. The cross-sectional area of lower tubular section 37 is larger than the area of outlet aperture 20. In some embodiments the cross-sectional area of tubular section is the same as the outlet aperture area. Outlet aperture 20 is disposed at the top of tubular section 36,3. In some embodiments, outlet aperture 20 may be located at other positions along the tubular section.

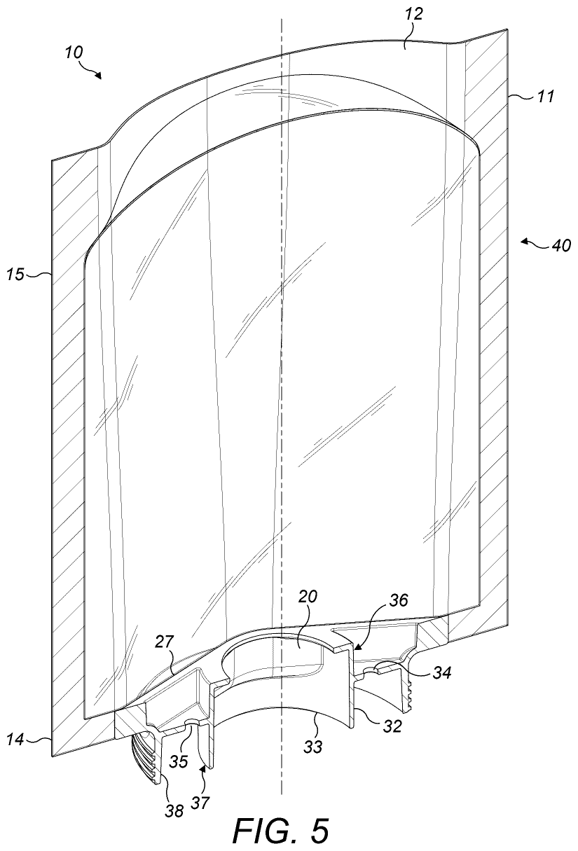

As shown in FIG. 1 rim 25 extends downwardly from the perimeter of upper side 23. Rim 25 and outlet 32 have coplanar bottom ends. As best shown in FIG. 5, base section 19 further includes a reinforcing rib structure underneath upper side 26. Rib structure has a plurality of radially spaced apart rib segments each interconnecting an inner sidewall of outer rim 25 with an outer sidewall of lower tubular section 37.

Water venting through holes 34, 35 are disposed spaced apart in upper side 26 of base section 19 on opposite sides, respectively, of outlet 32. Through holes 34, 35 are surrounded by continuous flange 27. In this manner, interior 16 is in fluid communication with the underside of base section 19 via respective through holes 34,35. Holes 34,35 provide an outlet for the water that might get trapped, or pooled, in the bag when it is stored for reuse. This is helpful to avoid mold build up during bag storage 10. In use, after priming the filter and unattaching the empty bag 10 from the filter, water venting through holes 34, 35 vent water that remains in cavities surrounded by continuous flange 27. In some embodiments, there may more or less through holes and in other embodiments no through holes at all.

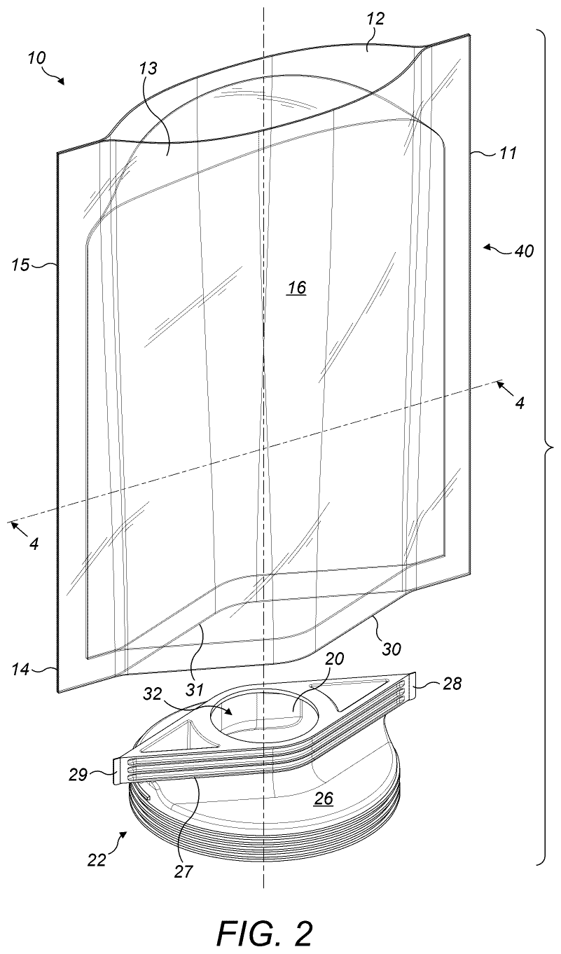

Turning now in more detail to continuous flange 27, flange 27 has a continuous sidewall standing upright from or proximate planar surface 26 of upper side 23. As best shown in FIG. 2, an upright surface on the exterior side of the flange sidewall serves as the sealing surface 24 to which inside edges of bottom end portions 30,31 of water container portion bottom end 14 are permanently sealed. The remaining bottom edge portions of bottom end 14 on either side of flange 27 are sealed directly together as are the vertical edges of water container portion 40. In some embodiments, seal surface 24 may be provided on a different surface of the flange sidewall. Sealing surface includes a plurality of longitudinal ribs to which bottom edges 30,31 of the water container portion 40 are bonded together, such as by fusing, molding, or welding together to ensure a leak free seal.

Continuous flange 27 is a rhombus (diamond) flange. The rhombus flange is sized and orientated concentric with the threads of filter connector component and the outlet. Acute angles between the adjacent rhombus sides are disposed at respective opposite sides of the perimeter of outer rim 25. In some other embodiments, continuous flange 27 may be a different shape. Flange upright sidewall and outlet 32 have coplanar upper ends. In some other embodiments, the height of the continuous flange upright sidewall may be higher or lower than the top of outlet 32. In yet some other embodiments, the twist handle design is omitted and continuous flange 27 has an annular shape or other shape.

It will appreciate that in some embodiments circular base section 19 may take other configurations than shown in the figures. Other base section structures are envisaged that provide a continuous flange sealing surface 24 surrounding outlet aperture 20 such that interior 16 of water container portion 40 is sealed off from exterior 17 other than by way of outlet aperture 20 and through holes 35.

As best shown in FIG. 2, a substantial part of water container portion bottom end 15 has a profile substantially corresponding to continuous flange sealing surface 24 such that bottom end 15 and continuous flange 27 substantially align with one another. In this manner, continuous flange 27 and inner region of the base section 19 surrounded by flange 27 effectively serves as a bottom gusset of water container portion 40. Central portions of bottom end edges 30, 31 of opposite sidewalls of water container portion 40 are maintained in a spread apart configuration across substantially the entire width of base section 19. Water container portion 40 is wider than treaded base section 19. The outer portions of bottom end 14 are sealed either side of flange 27 and extend beyond the outer perimeter of base section 19. Maintaining bottom end 15 in this configuration provides more bag volume and greater bag stability in use. By way of example, a 24 fl oz water portion container portions or more can be used. In some other embodiments, the entire water container portion bottom end 15 can be sealed to the sealing surface of flange 27.

Water container portion 40 is made from a flexible transparent plastic substrate which is fused to filter connector component 22. In some other embodiments, partially transparent, translucent or opaque flexible plastic may be adopted. Furthermore, in some other embodiments, water container portion 40 is made from other types of flexible material that may be fused or otherwise permanently sealed to the filter component. The plastic or other flexible material is sufficiently flexible such that, when priming bag 10 is coupled to a water filter, water container portion 40 is compressible by one and/or both hands to force water contained in water container portion 40 through the water filter to prime the filter without splitting, bursting or tearing of the water container portion 40. In some embodiments, the flexible material of the water container portion 40 has an inner lining of Polyethylene, and an outer layer of Nylon, and plastic filter connector component 22 is made out of HD400 (Polyethylene, High Density Copolymer).

Water container portion 40 is permanently sealed to filter connector component 22 such that, other than by means of fluid communication via outlet 32 of venting through holes 35, 36, interior 16 is sealed off from exterior 16. Water contain portion 40 has first and second vertical sidewalls opposing one another and extending from closed upper end 12 to bottom end 15. As best shown in FIGS. 3 & 4, first sidewall has opposing vertical edges that are sealed to corresponding opposing vertical edges of the second wall to form an envelope portion with an opening about at upper end 12. The opening at upper end 12 is closed off by an upper gusset 13 incorporated in upper end 12. Upper gusset 13 comprises one or more gusset portions of material sealed to upper ends of the first and second sidewalls.

Upper gusset 13 is made from the same or similar flexible material as the first and second sidewalls. In some other embodiments, upper gusset 13 is made from a different material. Upper gusset 13 covers a surface area that generally covers continuous flange 27. In this manner, upper gusset 13 in conjunction with continuous flange 27 provide more interior space as well as more strength. Providing more volume and strength to bag 10 improves the priming performance of the bag.

It would be appreciated that in some other embodiments, other types of gusset configurations may be used or there may be no gusset at all in which case the vertical sidewalls upper ends are sealed along the top edges thereof. Furthermore, it would be appreciated that other types of water container portion or configurations may be used. For example, in some embodiments, water container portion 40 may take a different shape to that shown in the drawings. Furthermore, in some embodiments, water container water container portion 40 may have more than 2 vertical sidewalls or even be one continuous sidewall such as in the case for a cylindrical or spherical enclosure for example.

By providing the single piece priming bag design, water filter priming bag 10 of the present technology can be directly coupled to a filter inlet of a pitcher gravity fed water filter. Direct coupling avoids the need for additional adapters or fittings to operably connect the bag to the inlet of the water gravity fed filter.

Filter priming bag 10 is designed to be a complete one-piece bag that screws directly onto a pitcher filter. Filter connector component 22 enables large priming bags in the region of 24 ounces, or larger in some embodiments, to be used to prime high performance filters with less priming cycles compared to smaller priming bags.

The priming bag design allows a robust large bag with a wide outlet aperture to be provided and used to prime high performance pitcher gravity fed filters such as filter 50 disclosed herein. As will be made apparent below, bag 10, in use provides the required water pressurization with larger bags (24 fl oz or even larger for some embodiments) but in a more targeted way to prime existing high performance pitcher gravity fed filters than known priming bags that use smaller bags (12 fl oz bags).

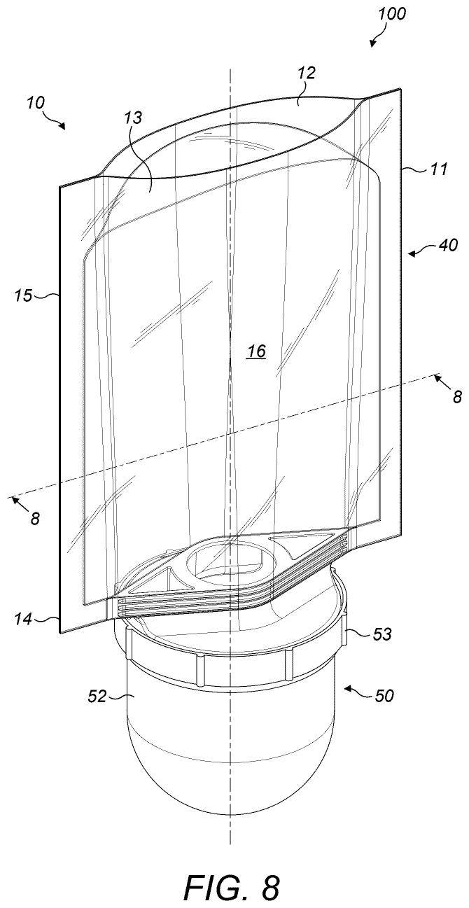

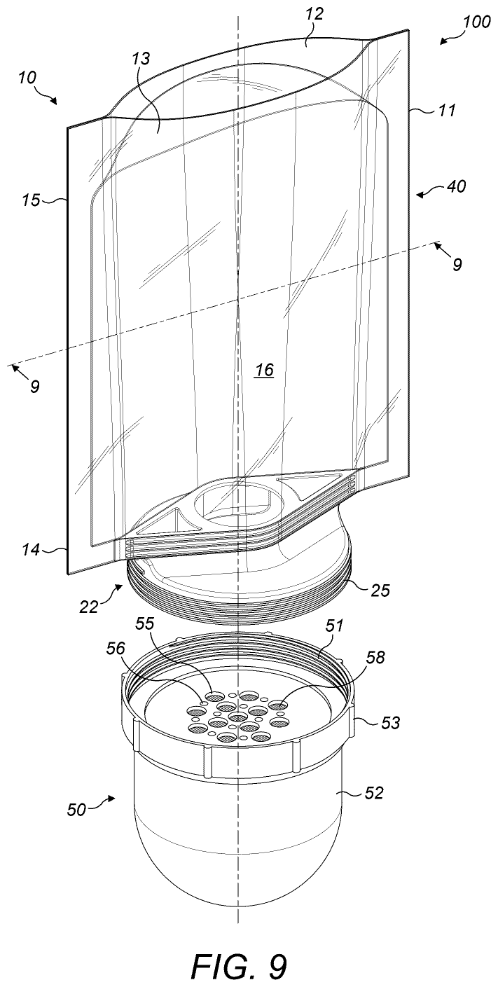

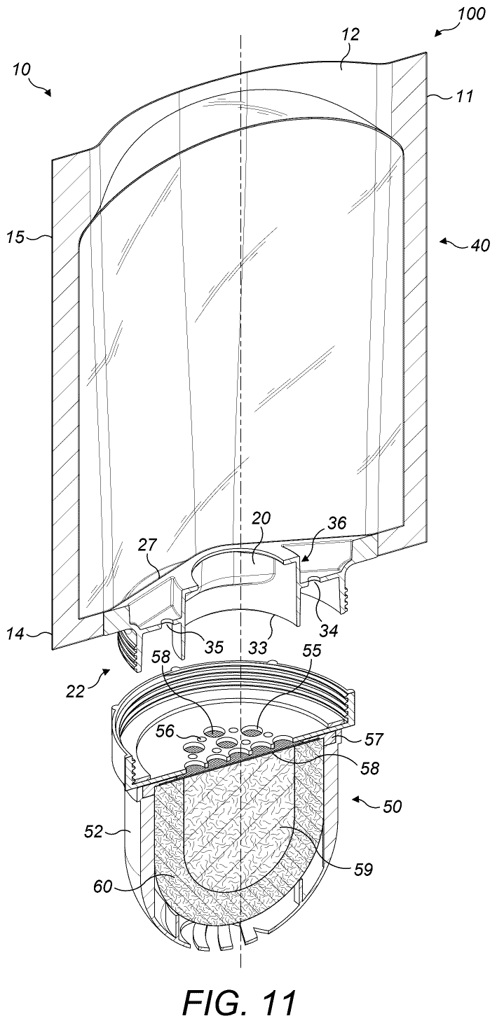

A water filter priming system 100 according some other aspects of the technology will now be described with reference to figures FIGS. 8 to 12 of the accompany figures in which the system is shown in assembled and disassembled configurations.

Water filter priming system 100 includes water filter priming bag 10 as shown and described with reference to FIGS. 1 to 7. It will be appreciated that in other embodiments, water filter priming bag 10 of water filter priming system 100 can be any one of the other embodiments of the water filter priming bags described herein.

Water filter priming bag 10 cooperates with a high performance pitcher water gravity fed filter 50. Filter 50 is configured for installing in a reservoir of a water filter pitcher (not shown). Unfiltered water poured from a faucet, such as a kitchen faucet, into an upper reservoir housing of the water pitcher filter passes through the filter. Filter 50 has a housing and filtering materials enclosed in the housing. The housing includes filter base 53 and a filter cup section 52 for holding filtering media 58, 59,60. Filtering media comprises a mesh sheet 58 and a high density filtering material(s) 59, 60 such as carbon or other filtering material. The high density filtering materials are densely packed in the gravity fed water filter housing.

In some embodiments, the high-performance gravity filter 50 is a filter that is capable of achieving at least 95% contaminant reduction rate of at least 100 contaminants that may be found in drinking water. These high-performance gravity filters typically must be more densely packed than standard gravity filters. In at least some embodiments, the high-performance gravity filter 50 is capable of achieving at least a contaminant reduction rate of up to 95% of ammonia, calcium hypochlorite, chloramine, chlorine, nitrate, sulfate, lead, and nickel. By way of example, one such high performance pitcher gravity fed water filter a Clearly filtered Water Pitcher Replacement Filter Manufactured by CLEARLY FILTERED INC., a corporation organized and existing under the laws of the state of California, with a place of business at 23121 Arroyo Vista, Suite B, Rancho Santa Margarita, CA 92688, UNITED STATES. Removal rates of containments for Model CF-PRF of the Clearly filtered Water Pitcher Replacement Filter are publicly available performance data and available at https://clearlyfiltered.com/pages/pitcher-performance-data (on the filing date of this application).

The capacity of the filter is 80 z or 10 cups.

The size/dimensions are 11.2 in diameter and 10.2 cm in height

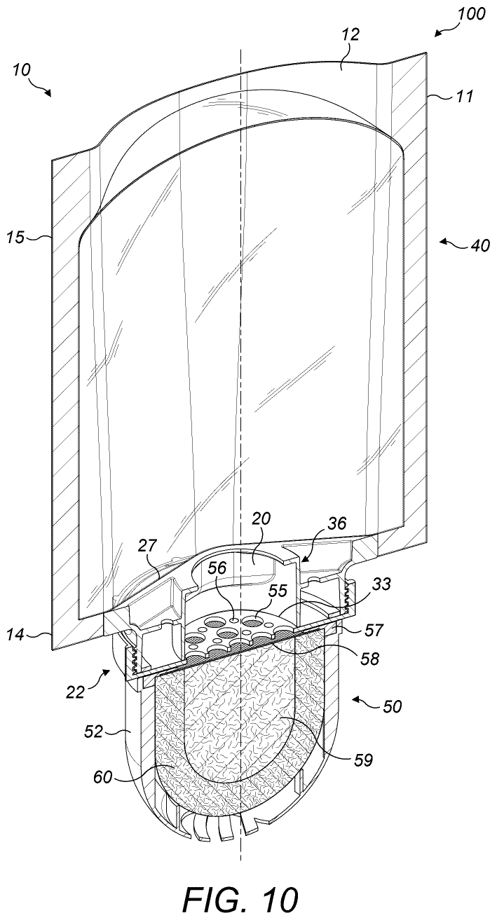

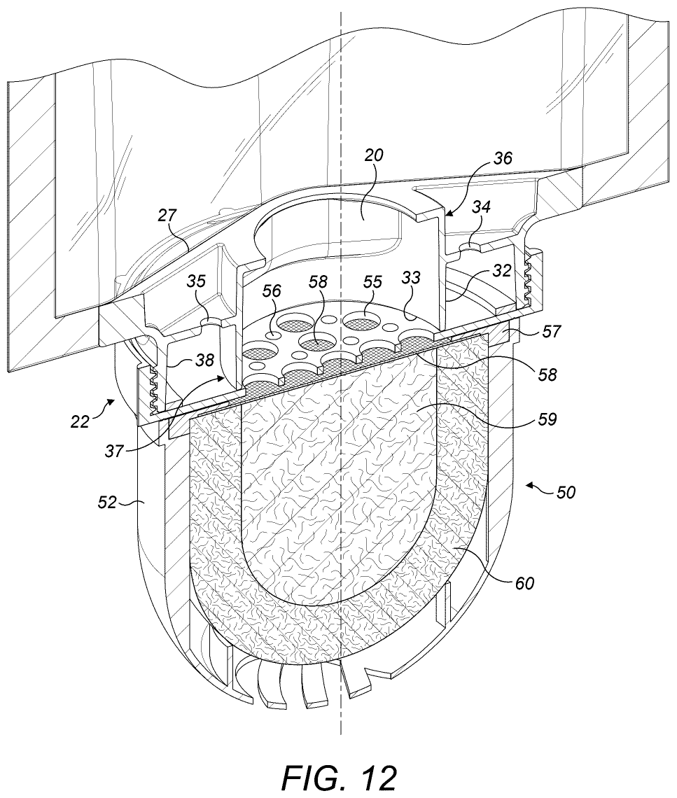

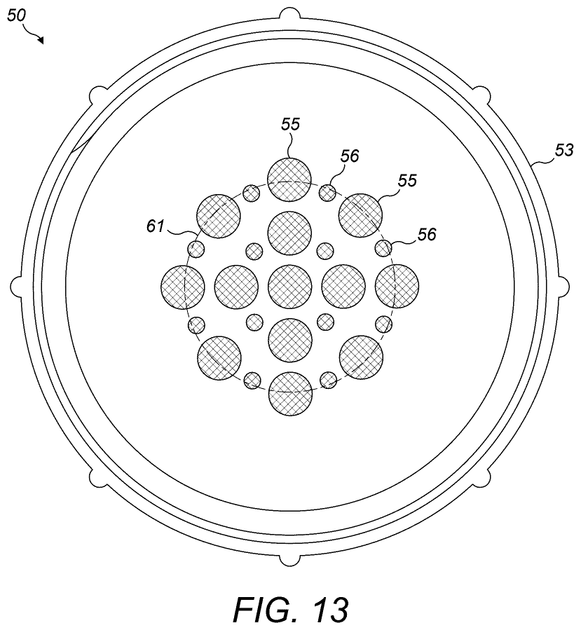

As best shown in FIG. 10, when the system is assembled, priming bag filter component connector 22 is threaded on filter 50. Filter base 53 has a threaded rim 38 threaded on to threaded outer rim 25. The filter housing includes a filter inlet. The filter inlet is made up of a constellation of inlet apertures nestled within the periphery of a circular surface area of the filter housing. The plurality of inlet apertures comprises large and small circular inlet apertures 55, 56 which are distributed spaced apart over the filter inlet surface area of filter base 53. As shown in FIGS. 12 and 13, inlet apertures 55,56 are distributed over a planar exterior side of filter base 53. In some embodiments, any one or combination of the number, shape and size of the inlet apertures differ from those shown in the figures. In some embodiments, the filter has only one inlet aperture.

As best shown in FIG. 12, when bag 10 is attached to the filter 50, filter connector component 22 is sealed areas and to the filter housing. Outlet 32 is disposed adjacent and substantially concentric with the filter inlet. Outlet bottom end 33 abuts the filter base planar face and substantially circumscribes the filter inlet. In this manner, water from water container portion 40 that is forced downwardly out of outlet aperture 20 is further targeted on the filter inlet.

As explained more fully below, the area of outlet aperture 20 is selected in size and position such that outlet 32 targets a substantial amount of the total inlet aperture areas and the large bag 10 is able to achieve adequate water pressurization during priming that is required to pressurize the high performance filter 50 with one use of the bag 10 (i.e. without having to refill the bag and continue priming). In regard to the outlet aperture size and location is optimized to provide a pressurized column of water directed over the intended target area. The reduced size of the outlet aperture 20 at the top of base section 9 compared to the outlet size at bottom end of base section 9 allows the end-user to generate more hydraulic pressure at the head when the bag is squeezed, via human power. Improving the head pressure, by way of mechanical advantage, accelerates the time required to prime a new filter while also reducing the risk of ‘channeling’ which can occur when the media is not primed w/o enough water volume and/or pressure.

Referring to FIG. 13, imaginary circle 61 represents the amount of the surface area of the filter inlet that will be covered by outlet aperture 20 when priming bag 10 according to some embodiments is attached to filter 50. Outlet aperture 20 covers a region of the filter inlet that comprises about 67% of the total inlet aperture area(s) of the pitcher gravity fed water filter. Outlet aperture 20 covers at least a portion of every inlet aperture 55,56. The outlet aperture area covers all the filter inlets disposed in a circular inner region of the filter inlet surface area and at least part of each filter inlet aperture area disposed in an annular outer region of the filter inlet surface area.

By way of example, in FIG. 13, there are 13 large inlet apertures and 12 small inlet apertures as shown the gravity fed filter of the accompany figures. The total inlet aperture area is: Large 13×49.585103 sq mm=644.60339+Small 12×7.8986727 sq mm=94.7840724 sq mm. Total inlet aperture areas: 739.387462 sq mm

In the example, the diameters of threaded filter component connector 22 and gravity fed water filter 50 are 11.2 cm, the aperture diameter of outlet aperture 20 is 3.68 cm, and the diameter of the outlet bottom end 33 is about 4.8 cm.

In the example, the coverage of the total inlet aperture areas by the priming bag outlet is 499.700994 sq mm. This coverage amounts to 67.58% of the total inlet aperture areas.

Known 12 oz priming bags for priming pitcher gravity fed filters such as filter 50 have a bag coverage of approx. 9.96% of the total inlet aperture areas.

In some other embodiments, the outlet aperture area covers at least a region of the filter inlet that comprises 50% of the total inlet aperture area(s) of the pitcher gravity fed water filter.

Expanding the outlet aperture to be larger than the inlet has the advantage of increasing the flow rate into the inlet and surface area contact between the water and the inlet, which reduces the amount of wasted water that can flow out the sides; this combined with making it physically easier for the end user to push the water through the filter by expanding the aperture are all technical advantages of at least some embodiments of the present technology.

Furthermore, targeted water pressurization of the filter inlet in conjunction with a robust, large capacity bag design enables priming of high performance pitcher gravity filter without the need to refill and reuse the priming bag.

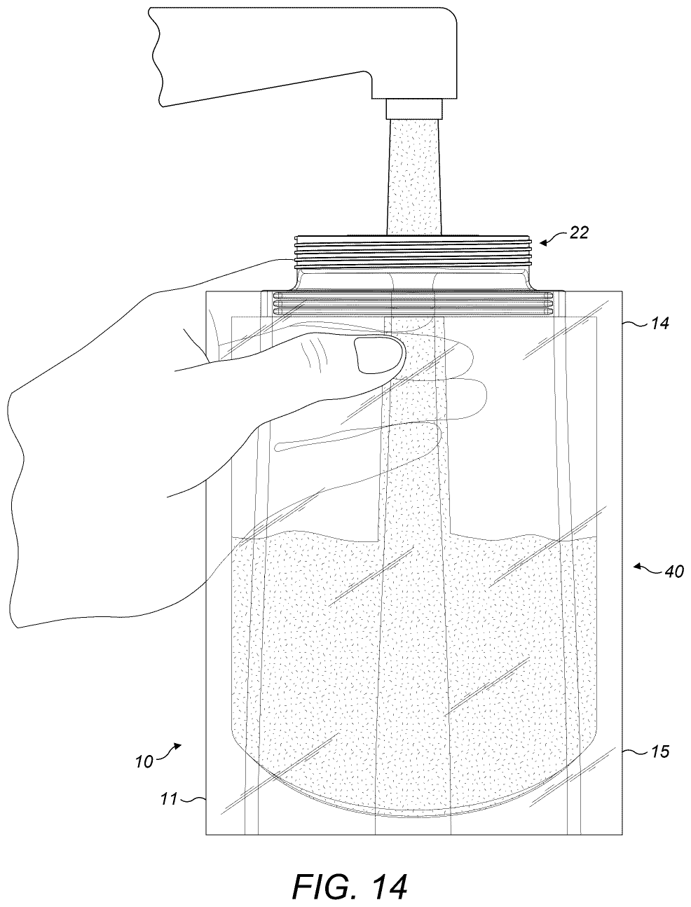

Methods for priming a gravity fed water filter using water filter priming bag 10 according to some aspects of the present technology will now be described with reference to FIGS. 14 to 17.

First, the priming bag 10 as shown and described with reference to FIGS. 1-7 is filled with water. FIG. 14 depicts priming bag 10 held upside down and filled with water via outlet 32. Handle 18 facilitates manipulation of bag 10 for filling the bag with water.

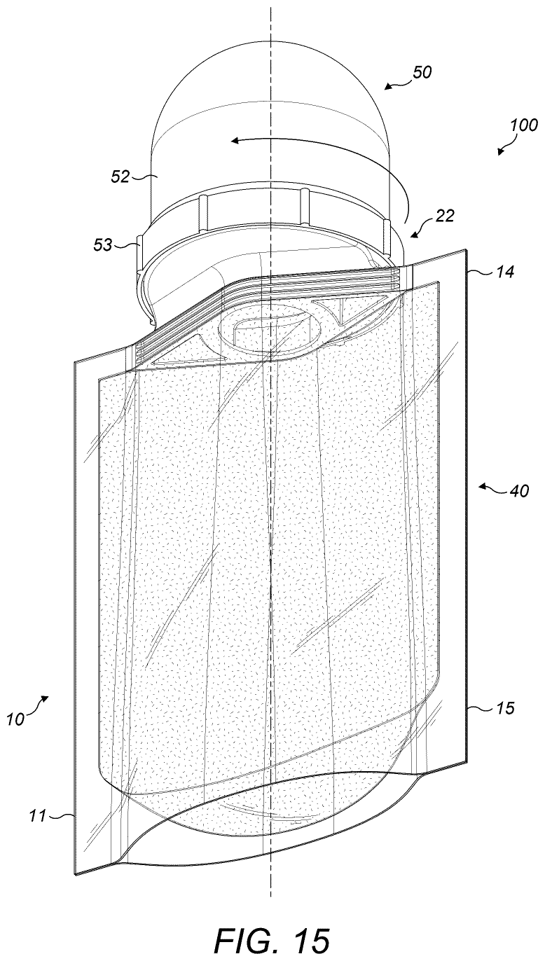

While holding water filter priming bag 10 bottom side up, water filter priming bag 10 is attached to gravity fed water filter 50. Gravity fed water filter 50 is as shown and described with reference to FIGS. 8-13. FIG. 15 indicates threading of bag 10 filled with water in FIG. 14 on to filter 50 by twisting filter threaded base 53 on to the corresponding threaded filter component 22. Handle 18 facilitates manipulation of priming bag 10 during assembly of filter 50 onto priming bag 50. Outlet aperture 20 covers about 67% of the total inlet aperture area(s) of filter 50. As indicated hereinbefore, in some other embodiments, outlet aperture 20 of filter 50 may be sized to cover a region of the filter inlet that comprises at least 50% of the total inlet aperture area(s) of the pitcher gravity fed water filter.

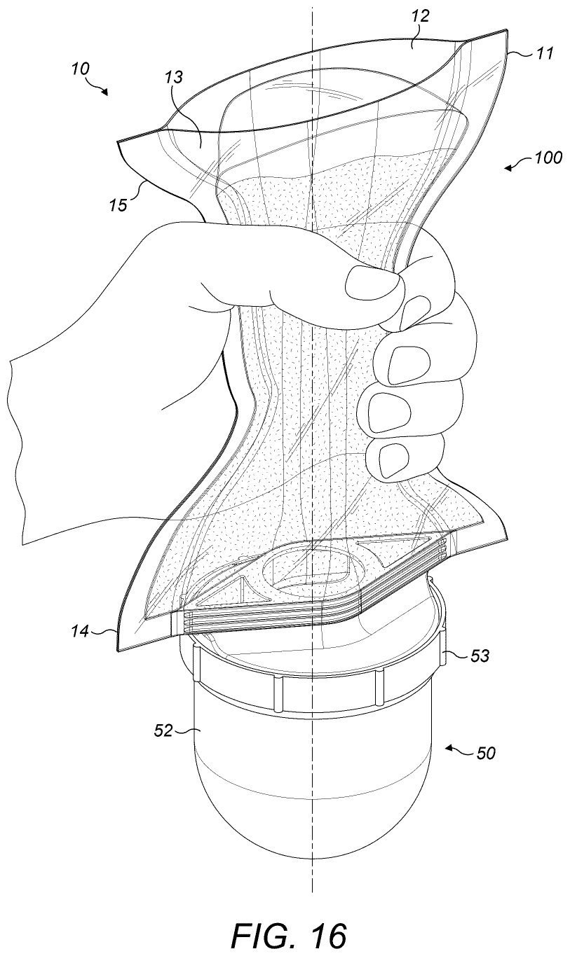

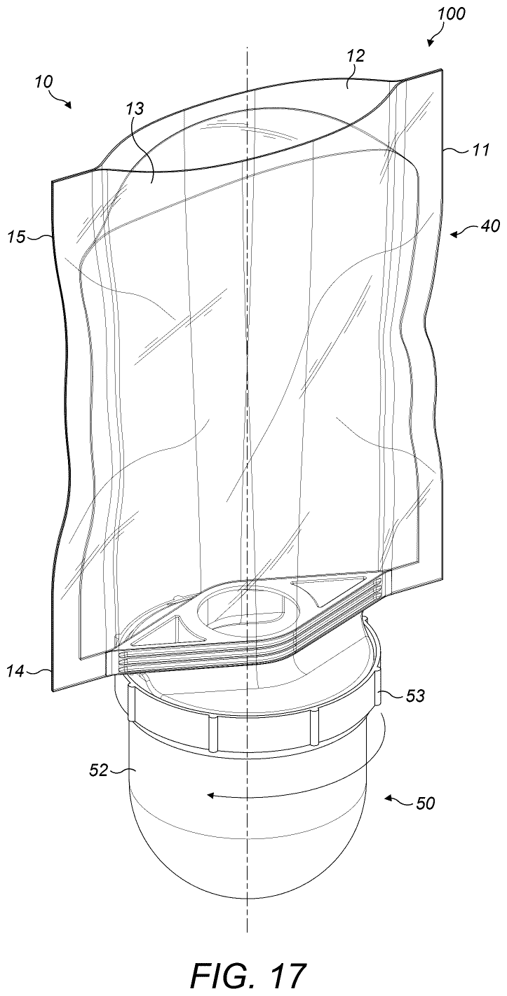

FIG. 16 depicts the water filter and the filled water filter priming bag apparatus sealed assembled together in FIG. 15 now flipped over into a priming configuration in which water container portion 40 is being squeezed to force the water down through the water filter. Handle 18 facilitates manipulation of the priming bag 10 during flipping the system over into the priming configuration. Filter 50 can be fully primed by squeezing water container portion 40 with one and/or both hands as required to force water from bag 10 through outlet 32 thereby providing highly target water pressurization of 67% of filter inlet aperture areas to adequately pressurize filter 50. Filter 50 is fully primed without having to refill bag 10 and repeat the priming process. In some embodiments, the priming process is repeated, if appropriate. FIG. 17 depicts filter 50 being unscrewed from priming bag 10 by twisting bag connector 22 off corresponding threaded filter base 53 after having primed filter 50 with bag 10. Handle 18 facilitates manipulation of bag 10 during unscrewing of the bag from the filter.

It will also be understood that in the accompany figures the high performance gravity fed water filter is shown and described for the purpose of explaining the configurations and operations of water filter priming bag 10 in use but that in some other embodiments, water filter priming bag 10 may be used to prime other types of water filters.

Priming bag 10 makes the use of high performance pitcher gravity fed filters 50 more practical, more usable, and significantly more effective at removing contaminants. Without priming bag 10, filtration quality would likely be compromised unless compensated for by the significant amount of time it would take for the pitcher filter to achieve a consistent flow rate.

The priming bag, system and methods of at least some embodiments of the present technology effectively simplifies the priming process, allowing end users of the filters to enjoy the high-value performance benefits of a high-density filter, packaged in a low-cost, gravity-fed system.

The priming methods of the present technology are unique priming processes that are simple, fast, and repeatable.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “hand-held”) may be occasionally interchangeably used with its non-hyphenated version (e.g., “hand held”), a capitalized entry (e.g., “Filter”) may be interchangeably used with its non-capitalized version (e.g., “filter”), a plural term may be indicated with or without an apostrophe (e.g., PE's or PEs), and an italicized term (e.g., “filter”) may be interchangeably used with its non-italicized version (e.g., “filter”). Such occasional interchangeable uses shall not be considered inconsistent with each other.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present. The description herein is illustrative and not restrictive. Many variations of the technology will become apparent to those of skill in the art upon review of this disclosure.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

1. A hand-held water filter priming bag for priming a high performance gravity fed water filter comprising
a water container portion made from flexible material and a
a filter connector component made from a rigid material;
the water container portion being permanently sealed to the filter connector component;
wherein the water container portion has a closed upper end and a bottom end;
wherein the filter connector component comprises
a base section;
a handle integrated with an upper side of the base section;
and
an outlet;
wherein the handle extends longitudinally along at least substantially the entire diameter the base section;
wherein the handle comprises a continuous flange spanning substantially the diameter of the base section and surrounding said outlet,
wherein at least a portion of the bottom end of the water container portion is permanently sealed to a sealing surface of the continuous flange surrounding said outlet; and
wherein an interior of said water container portion is in fluid communication with an exterior of the water filter priming bag via said outlet.

2. The hand held water filter priming bag of claim 1, wherein the filter connector component is a molded single piece body.

3. The hand held water filter priming bag of claim 1, wherein the filter connector component is a threaded filter connector component for threading to a pitcher gravity fed water filter.

4. The hand held water filter priming bag of 3, wherein the outlet, continuous flange and threads of the threaded filter connector component are concentric with one another.

5. The hand-held priming bag device of claim 4, wherein opposite ends of the handle extend longitudinally beyond the perimeter of the upper side of the base section.

6. The hand-held priming bag device of claim 1, wherein the continuous flange comprises a sidewall standing upright from the upper side of said base section.

7. The hand-held priming bag device of claim 6, wherein the sealing surface comprises an upright surface on the exterior side of the flange sidewall.

8. The hand held priming bag device of claim 1, wherein the continuous flange is a rhombus flange.

9. The hand-held priming bag device of claim 1, wherein the outlet has a cross-sectional area that corresponds to a substantial surface area of a filter inlet of a high performance pitcher gravity fed water filter.

10. The hand-held priming bag device of claim 1, wherein the upper end of the water container portion incorporates an upper gusset, the upper gusset having a surface area covering the continuous flange.

11. The hand-held water filter priming bag of claim 1, wherein the outlet comprises a tubular section extending perpendicularly between the upper side and a bottom of said base section.

12. The priming bag device of claim 1, wherein a pair of venting through holes are disposed in the upper side of the base section, wherein the through holes are surrounded by the continuous flange and spaced either side of the outlet, the interior of the water container portion being in fluid communication with the underside of the base section via the respective through holes.

13. A water filter priming system comprising
a gravity fed water filter housing;
and
a hand-held priming bag of claim 1 attachable to said gravity fed filter housing;
wherein the gravity fed water filter housing has a filter inlet comprising at least one inlet aperture; and
wherein, when the hand held water filter priming bag is attached to the gravity fed water filter housing, the filter connector component of the hand held water filter priming bag is substantially sealed to the filter housing, the outlet of the hand held priming bag is disposed adjacent and substantially concentric with the filter inlet, and an aperture of the outlet has an aperture area that covers a substantial amount of the total inlet aperture area(s) of the pitcher gravity fed water filter.

14. The water filter priming system of claim 13, wherein the filter inlet comprises a plurality of inlet apertures distributed spaced apart over a surface area of the filter housing.

15. The water filter priming system of claim 14, wherein, when the hand-held water filter priming bag is attached to the gravity fed water filter housing, the outlet aperture area covers a surface region of the filter housing that comprises at least 50% of the total inlet aperture area(s) of the pitcher gravity fed water filter.

16. The water filter priming system of claim 14, wherein, when the hand-held water filter priming bag is attached to the gravity fed water filter housing, the outlet aperture area covers a surface region of the filter housing that comprises at least 67% of the total inlet aperture area(s) of the pitcher gravity fed water filter.

17. The water filter priming system of claim 14, further comprising filter media enclosed in the filter housing.

18. The water filter priming system of claim 17, wherein the gravity fed water filter is a high performance pitcher gravity fed water filter.

19. The water filter priming system of claim 18, wherein the high performance gravity filter is configured to have at least a contaminant reduction rate of up to 95% of ammonia, calcium hypochlorite, chloramine, chlorine, nitrate, sulfate, lead, and nickel.

20. Methods for priming a gravity fed water filter comprises providing a water filter priming bag as claimed in claim 1;
filling the water filter priming bag with water;
while holding the water filter priming bag filled with water, attaching a high-performance pitcher gravity fed water filter to the water filter priming bag so that outlet aperture covers a surface area of the filter housing that comprises at least 50% of the total inlet aperture area(s) of the pitcher gravity fed water filter;
fully priming the gravity water fed filter with one use of the water filter priming bag by squeezing the filled water container portion to force the water in the water container portion through the outlet and through the filter inlet; and
detaching the filter priming bag from the high performance pitcher gravity fed water filter.
